(19) United States
(12) Patent Application Publication
(10) Pub. No.: US 2024/0344521 A1
(43) Pub. Date: Oct. 17, 2024

(54) Method for Detecting a Fault, in Particular an Impeller Blockage, in a Centrifugal Pump, and Centrifugal Pump

(71) Applicant: KSB SE & Co. KGaA, Frankenthal (DE)

(72) Inventors: Vincent BECKER, Erzenhausen (DE); Martin ECKL, Frankenthal (DE); Benedikt MUELLER, Frankenthal (DE); Sven URSCHEL, Kaiserslautern (DE); Jochen SCHAAB, Frankenthal (DE)

(21) Appl. No.: 18/685,022

(22) PCT Filed: Aug. 15, 2022
(86) PCT No.: PCT/EP2022/072770

§ 371 Date: Feb. 20, 2024

(30) Foreign Application Priority Data
Aug. 20, 2021 (DE) 10 2021 121 672.9

(51) Int. Cl. F04D 15/00; F04D 13/06; F04D 15/02

(52) U.S. Cl. CPC F04D 15/0088; F04D 13/06; F04D 15/0236; F04D 15/0254

(57) ABSTRACT

A method for identifying a fault in an impeller blockage in a centrifugal pump includes a determining step and a calculating step. The determining step includes determining the fault frequency f_{r,pump} of at least one fault-indicating harmonic of a motor current on the basis of a fault model, wherein the centrifugal pump has a three-phase drive motor. The calculating step includes calculating a harmonic amplitude î_{f} of the motor current for the at least one determined fault frequency f_{r,pump} by transforming the three-phase motor current into a dq current coordinate system that contains currents i_{d} and i_{q} and rotates at the fault frequency f_{r,pump}. A geometric sum of direct components of the currents i_{d} and i_{q} in the dq current coordinate system corresponds to the harmonic amplitude î_{f}.

### CROSS REFERENCE TO RELATED APPLICATION

This application claims priority under 35 U.S.C. § 119 from German Patent Application No. 102021121672.9, filed Aug. 20, 2021, the entire disclosure of which is herein expressly incorporated by reference.

### BACKGROUND

The disclosure relates to a method for identifying a fault, in particular for identifying an impeller blockage, in a centrifugal pump having a three-phase drive motor by evaluating at least one harmonic of the motor current.

Circulation pumps are used in drinking water, cooling and heating systems. In the last few decades, a lot of effort has gone into increasing the efficiency of circulating pumps. In the process, development has been substantially focused on improvements to the motor and impeller design and the control algorithms. Implementations of state monitoring methods in circulating pumps are so far in short supply. Studies have already shown, however, that possible material deteriorations or damage to the pump do not necessarily result in pump failure but initially may only cause the motor or the pump to operate at reduced efficiency. It is therefore imperative to be able to find such degradations in efficiency as early as possible by way of a fault identification method.

In order to avoid additional costs during the manufacturing of the pump, the fault identification method utilized should be able to be carried out as much as possible on the already existing hardware of the pump. Circulating pumps according to the prior art are embodied as integrated products having a built-in microprocessor unit for carrying out a control algorithm, a variable-speed drive (frequency converter) and permanent magnet synchronous motors (PSMs) and an impeller. Separate current sensors measure current values as input variables for the sensorless controller of the motor. In this hardware configuration having current sensors and a microprocessor unit, circulating pumps offer a platform for implementing current-based fault identification methods.

The prior art proposes various methods for current-based fault identification of motors. The most widespread method may be motor current signature analysis (MCSA) which performs fault detection by means of spectral analysis of a phase of the motor current in the steady state. For the evaluation of the spectrum of a current signal, a preceding transformation in the frequency domain is required, which is possible via discrete Fourier transformation (DFT). However, the implementation of DFT requires high computational effort and a large memory capacity. For this reason, fast Fourier transformation (FFT) is often reverted to in practice. However, the implementation of FFT on a microprocessor unit is associated with certain hurdles too. Disadvantages of FFT that may be mentioned are the high frequency resolution required, the leakage effect and the assumed steady-state operation during the observation period.

### SUMMARY

One object of the present disclosure is to present an optimized method for current-based fault identification, which can be readily implemented on a microprocessor unit of a pump. In particular, the sought-after method intends to minimize the memory requirement and the number of operations that are to be carried out.

This object and other objects are achieved by a method according to the features of claim 1. Advantageous embodiments of the method are the subjects of the dependent claims. In addition, the method is achieved by a pump, in particular a centrifugal pump, having a microprocessor unit for carrying out the method.

The method according to the disclosure is preferably performed on the integral microprocessor unit of the pump, in particular for the regular running time of the pump. However, performance on an external computing unit is just as conceivable and should likewise be encompassed by the disclosure. The explanations below primarily relate to performance and implementation of the method on the integral microprocessor unit of a pump, in particular a centrifugal pump.

According to the disclosure, in a first method step, the frequency of at least one fault-indicating harmonic of the motor current is determined by means of a fault model. The fault model can be stored in the pump. This step accordingly allows one or more specific frequencies in the motor current to be ascertained, it being possible to identify a fault during running operation of the pump by observing these frequencies. In particular, the occurrence of the harmonic or the perceptible change therein can be characteristic of a specific fault. Frequencies in the sidebands of the current spectrum, for example, can be of importance. Possible faults which can be derived from the characteristics of at least one harmonic of the current are mechanical faults, such as bearing wear of the pump or of the motor and possible impeller faults. This also includes a blockage of the impeller caused by adhering solids in the conveying medium. The identification of certain operating situations, such as a dry run of the pump, is possible too.

A further method step intends to ascertain the amplitude of the harmonic of the motor current for the previously determined at least one fault frequency. For this purpose, the transformation of the multi-phase, in particular three-phase, motor current into a two-axis dq current coordinate system is proposed. The resulting current coordinate system rotates at the fault frequency of the fault-indicating harmonic or the corresponding angular velocity. The current vector which thus arises in the dq coordinate system accordingly consists of a rotating current vector and a steady-state current vector. The latter corresponds to that component of the motor current which is allotted to the harmonic and which is constant over time in the chosen representation and therefore forms a direct component of the currents i_{d} and i_{q}. In the coordinate representation, the amplitude of the fault-indicating harmonic can be ascertained by calculating the geometric sum of these direct components. The proposed approach requires considerably fewer operations and resources than performing an FFT or DFT, for example, and as a result, on account of the comparatively lower resource requirements, can be readily implemented on an internal microprocessor unit of a pump. The solution can thus be implemented completely in a software-based manner on an existing microprocessor unit in order to control a centrifugal pump. Use can be made of sensors that are present anyway for the current measurement of the motor currents; an additional hardware extension is not required.

According to one advantageous embodiment, the at least one fault frequency is calculated on the basis of the stator frequency of the drive motor and/or the number of pole pairs of the stator. Particularly preferably, the fault frequency is obtained by solving the following formula

$${f}_{r , pump} = ( 1 \pm \frac{1}{p} ( 1 - s ) ) \cdot {f}_{s} ,$$

wherein p represents the number of pole pairs of the stator, s is the slip of the drive motor used and fₛ is the stator frequency. In principle, the slip s is only of importance in asynchronous motors. Conversely, for synchronous motors, the slip is s=0.

As was already explained above, the direct components of the currents i_{d} and i_{q}, which are determined by transformation, provide the necessary information for ascertaining the harmonic amplitude. A simple approach for determining these direct components is using a low-pass filter, by means of which the time-variable alternating component of the corresponding currents i_{d}, i_{q} is filtered out. Ideally, a first-order low-pass filter is used. Particularly preferably, use is made of a first-order Butterworth filter the transfer function of which can be defined according to

$$H ( z ) = \frac{1 - {e}^{{ω}_{c} T}}{z - {e}^{{ω}_{c} T}} ,$$

wherein T preferably corresponds to the sampling rate of the processor unit. The cutoff frequency ω_{c} must be chosen to be relatively small in order to remove the oscillation as much as possible.

According to one advantageous embodiment of the disclosure, for the transformation of the motor currents into the dq current coordinate system, the Park transformation is used, in particular according to the formula

$${\underline{\vec{l}}}_{dq} = {\underline{\vec{l}}}_{αβ} \cdot {e}^{- i ( {ω}_{F} t )} ,$$

wherein \vec{i}_{αβ} is a space-vector representation of the three-phase motor current in a stator coordinate system and ω_{F} is the angular velocity corresponding to the fault-indicating oscillation frequency according to ω_{F}=2πf_{r,pump}. Required trigonometric functions for using the Park transformation can be realized within the microprocessor unit by way of lookup tables containing a defined number of value pairs in order to minimize the memory requirement of the microprocessor unit. The use of 300 to 400 value pairs, in particular 360 value pairs, is conceivable.

The aforementioned Park transformation is often also used in field-oriented control (FOC) of an electric motor, wherein the i_{q} current coordinate system is not ascertained on the basis of a specific frequency of a harmonic in that case but instead on the basis of the present rotor speed such that a steady-state coordinate system with regard to the rotor arises. If this is the case, the method according to the disclosure can already revert to an existing control element of the pump for the FOC.

Since the Park transformation requires a space-vector representation of the three-phase motor current, the three-phase motor current initially has to be transformed into a two-dimensional space-vector representation. This can be done by means of Clarke transformation per transformation into a stator coordinate system. An already existing control element of the pump controller can theoretically be reused here too or instead only the information about the space-vector representation is taken from the control element.

In practice, centrifugal pumps, in particular circulating pumps, are often pressure-controlled. This has the consequence that, when load varies, the speed of the pump can also change during operation. The same accordingly applies to the motor current consumption. In order to take this into account, it is advantageous if a load-independent severity factor is derived from the calculated oscillation amplitude so that it is possible to compare this severity factor with a reference value in a manner independent of the operating point. For example, it is conceivable for a load-independent severity factor to be calculated by forming the relationship between the harmonic amplitude and the amplitude of the torque-generating component of the motor current, in particular the amplitude of the motor current i_{q}. The resulting severity factor is thus normalized and independent of the present current consumption of the motor.

In one advantageous enhancement of the method, once the calculation of the harmonic amplitude and/or of the severity factor has been completed, a comparison with a reference value or a limit value can be carried out. It is also conceivable to check whether the calculated value is within a permissible range of values. The pump can perform this check continuously, periodically or at selected points in time during the running operation of the pump. If a deviation from the reference value is found, if the limit value is exceeded or not reached, or if said calculated value is not within the permissible range, this indicates an anomaly or a fault of the pump. The method can initiate the outputting of a fault message or even the intervention in the regular pump controller, in order to avoid any consequential damage.

According to another advantageous implementation of the disclosure, provision can additionally be made for an external, central evaluation unit to be provided, which evaluation unit is directly or indirectly in communication with two or more centrifugal pumps. In this case, it is useful if the values for the harmonic amplitude and/or the severity factor which are calculated individually by the respective centrifugal pumps are transmitted to the central evaluation unit for the purpose of fault identification and fault monitoring. The centrifugal pumps do not therefore monitor the calculated values by themselves but instead transmit them to a central evaluation unit. This approach has the advantage that an external evaluation unit can collect a multiplicity of possible severity factor values or harmonic amplitude values and compare these values with one another. This makes it possible to ascertain value outliers from a multiplicity of comparable pump types. The comparable pump types are for example of identical or similar construction and are likewise characterized by a similar application. The operating parameters of the comparable pumps are also within defined ranges of values. Operating parameters comprise for example the operating point, the speed, possible temperature values of the conveying medium, the running time or the age of the pump. Accordingly, in addition to comparing the collected values for the harmonic amplitude and/or the severity factor, provision is thus made for operating parameters and/or properties of the supplying centrifugal pumps to be taken into account too.

As was already described above, the evaluation unit is configured as an external entity. Usefully, the latter can be implemented as a cloud-based solution. The communication with the centrifugal pumps can be made via a dedicated interface. However, it is just as conceivable to revert to an existing communication infrastructure and technology, for example by supplementing a pump with a corresponding gateway which transmits the data to the evaluation unit via existing communication technologies.

In addition to the method according to the disclosure, the application also relates to a pump, preferably a centrifugal pump and in particular a circulating pump, the hydraulic unit of which is driven by a three-phase drive motor, in particular a permanent magnet synchronous motor. The centrifugal pump further comprises a microprocessor unit which is configured so as to carry out the method according to the disclosure. The centrifugal pump can likewise have or be connected to a possible communication module in order to be able to transmit calculated harmonic amplitude values and/or severity factor values to an external evaluation unit. The microprocessor unit preferably takes over the regular speed control of the pump, in particular on the basis of field-oriented control.

In addition to the centrifugal pump according to the disclosure, the disclosure also relates to a superordinate system consisting of two or more centrifugal pumps and an external evaluation unit which is communicatively connected to the at least two centrifugal pumps. In this case, the centrifugal pumps carry out the corresponding method for calculating the harmonic amplitude or a severity factor, wherein the latter are transmitted to the external evaluation unit. The latter compares the received values with one another in order to be able to ascertain faulty pumps from the transmitted datasets.

Further advantages and properties of the disclosure are intended to be explained in more detail below on the basis of exemplary embodiments. In the figures:

### BRIEF DESCRIPTION OF THE DRAWINGS

FIGS. 1a, 1b, 1c show different current spectrum diagrams for visualizing the fault-indicating harmonic frequencies;

FIG. 2 shows a comparison of the steady-state stator coordinate system and of the rotating dq coordinate system;

FIG. 3 shows an illustration of the dq coordinate system rotating at the fault frequency for the fault analysis;

FIG. 4 shows a block diagram for illustrating the individual method steps for fault monitoring; and

FIG. 5 shows a system diagram of the system.

### DETAILED DESCRIPTION

The disclosure is concerned with a method for current-based fault monitoring of a centrifugal pump, in particular of a circulating pump, which method is optimized with regard to the memory requirement and the number of operation steps that are to be carried out. The idea of the disclosure is initially based on the assumption that mechanical faults in the pump or in the drive motor affect certain frequencies of the current spectrum.

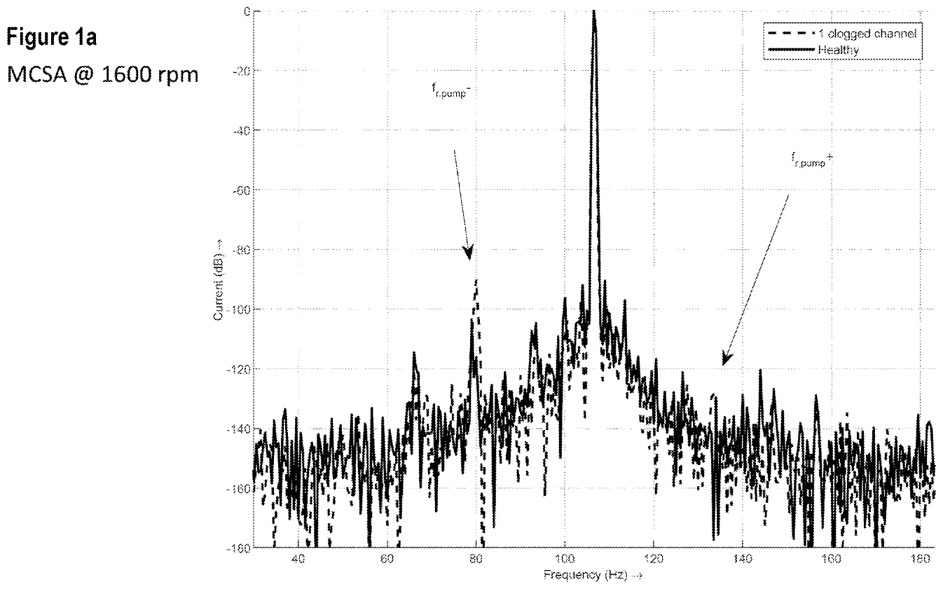

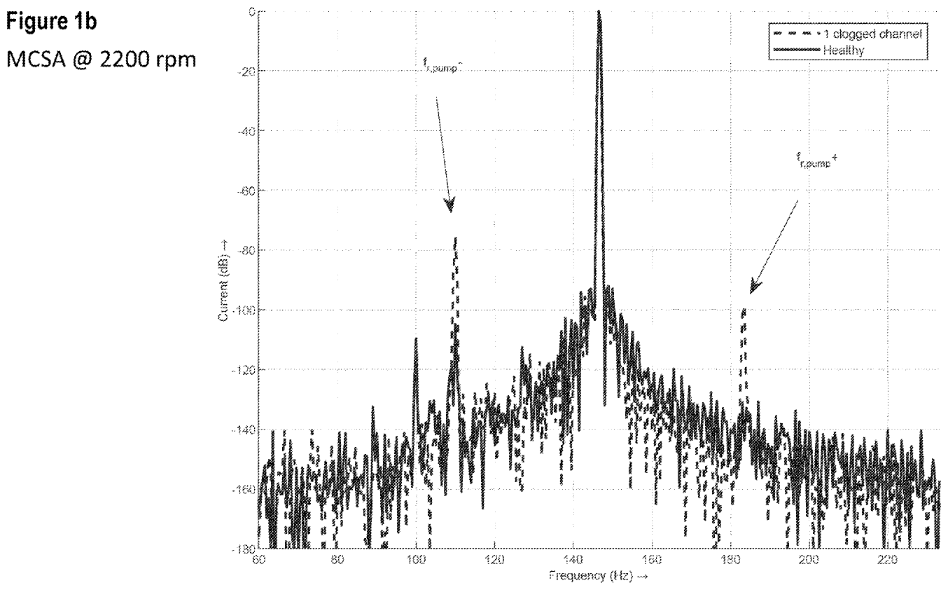

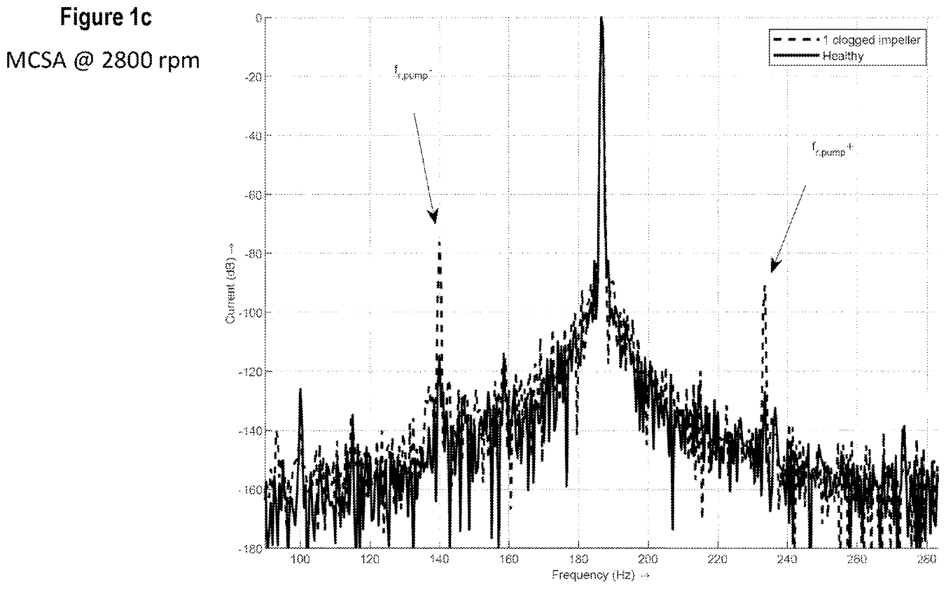

FIGS. 1a, 1b and 1c show, by way of example, the respective current spectrum of the same motor phase at the speeds 1600 rpm, 2200 rpm and 2800 rpm of a heat circulating pump having an impeller with seven channels. In the respective diagram illustration, the current spectrum both for the fault-free case (curve with the solid line) and for the fault case (curve with the dashed line) is included, wherein the latter was caused by an artificially caused blockage of one channel of the impeller. The respective spectra are illustrated in dB, wherein the fundamental oscillation of the illustrated motor phase is normalized to 0 dB. The amplitudes of the sidebands f_{r,pump}+, referred to as the upper sideband below, and f_{r,pump}−, referred to as the lower sideband below, are designated in the figures.

At a speed of 1600 rpm (FIG. 1a), the fault “impeller blockage” causes an increase in the amplitude of the lower sideband from −103.5 dB in the healthy state to −90.1 dB in the faulty state. The amplitude of the upper sideband remains about the same. At a speed of 2200 rpm (FIG. 1b), the difference between the current spectra becomes clearer. The lower sideband amplitude increases from −104.8 dB to −75.5 dB and the upper sideband amplitude increases from −131.0 dB to −98.8 dB. The spectrum at 2800 rpm looks similar to the spectrum of 2200 rpm, but the amplitudes at the sidebands are even more pronounced. The amplitude of the lower sideband increases from −114.8 dB to −76.0 dB and that of the upper sideband increases from −127.1 dB to −90.9 dB. The results of the upper spectrum analysis show that information about the state of the pump is contained in the current signal, wherein the differences between healthy and faulty become more apparent at higher speed.

For the fault monitoring, specific frequencies of the current spectrum therefore need to be evaluated, wherein the most promising approach in regard to minimizing the memory requirement and the number of operations for the application in circulating pumps is based on the multiple reference frame theory. Similar to field-oriented control (FOC), the idea is to let a coordinate system rotate. Whereas in FOC the coordinate system rotates in the frequency of the rotor, it rotates, in the sense of fault identification, with the frequency of a fault.

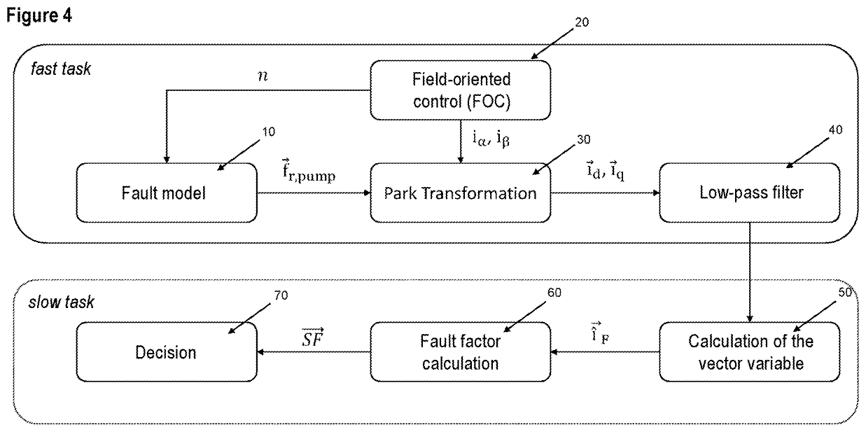

As was already shown with reference to FIGS. 1a, 1b, 1c, imbalance and alignment errors of the mechanics in the hydraulic part and drive part of the pump affect the amplitudes of the sidebands of the current spectrum. Said imbalance and alignment errors can be caused by a blocked impeller, a bearing fault or else dry running of the pump. The procedure of the method according to the disclosure is shown in simplified fashion in the block diagram of FIG. 4. The above-mentioned, relevant fault frequency f_{r,pump} can be calculated by reverting to a fault model 10 which calculates the fault frequency according to formula (1) on the basis of the stator frequency (rotor speed n), the motor slip s and the number p of pole pairs of the drive motor:

$${f}_{r , pump} = ( 1 \pm \frac{1}{p} ( 1 - s ) ) \cdot {f}_{s} . \qquad ( 1 )$$

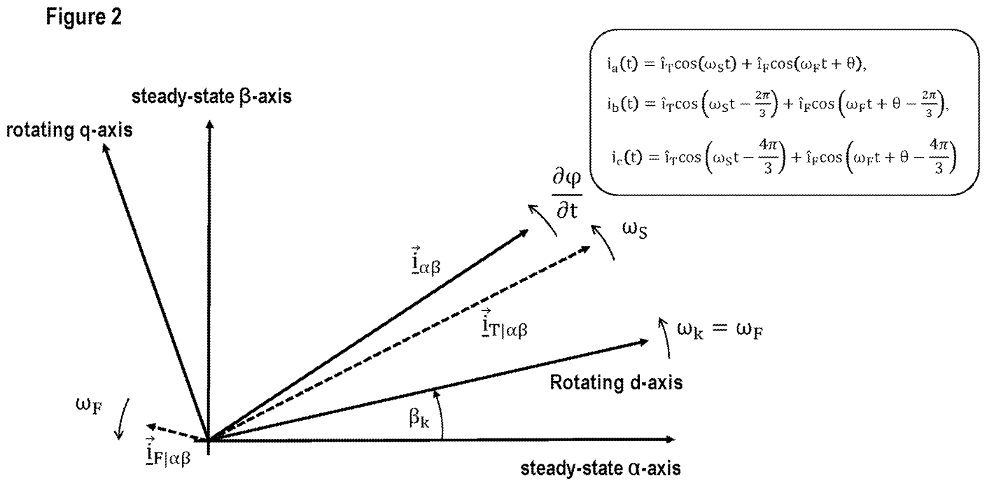

In the case of a three-phase motor, the motor currents can be combined in a space vector. For this, it is assumed that the sum of the phase currents is zero. The real part of the space vector is denoted by α current and the imaginary part by β current. The α-β coordinate system (see FIG. 2) is referred to as stator-fixed coordinate system (stator coordinate system). The transformation of the three-phase stator currents into the two-phase α-β current is referred to as Clarke transformation.

In order to drive an AC motor, a pump controller transforms the stator-fixed α-β current into the rotor-fixed dq current, which is referred to as Park transformation. From a mathematical point of view, a coordinate system is made to rotate in line with the speed n of the rotor. As a result, the dq current is a DC value which can be used for controlling the motor. The interesting aspect is that the vector sum of d and q current corresponds exactly to the amplitude of the fundamental oscillation of the motor current. The method according to the disclosure for automated fault identification makes use of this principle from the prior art.

Looking at a real motor, the phase current and therefore the current space vector is thus superimposed with oscillations, the extent of which increases during faulty operation of the pump or of the drive motor. For the method according to the disclosure, it is now assumed that the motor current is the sum of the torque-forming current having the amplitude î_{T} and the speed ω_{S} and of a harmonic having the amplitude î_{F} and the speed ω_{F}. The motor currents of the three phases can be calculated according to following equations (2):

$${i}_{a} ( t ) = {\hat{i}}_{T} cos ( {ω}_{S} t ) + {\hat{i}}_{F} cos ( {ω}_{F} t + θ ) \\ {i}_{b} ( t ) = {\hat{i}}_{T} cos ( {ω}_{S} t - \frac{2 π}{3} ) + {\hat{i}}_{F} cos ( {ω}_{F} t + θ - \frac{2 π}{3} ) \\ {i}_{c} ( t ) = {\hat{i}}_{T} cos ( {ω}_{S} t - \frac{4 π}{3} ) + {\hat{i}}_{F} cos ( {ω}_{F} t + θ - \frac{4 π}{3} ) \qquad ( 2 )$$

In this case, î_{F} contains information about the state of the pump and about the severity of the fault. As an example, ω_{F} can be calculated on the basis of equation (1).

As illustrated in FIG. 2, the current space vector \vec{i}_{αβ} in the stator coordinate system is equal to the sum of the torque-forming component \vec{i}_{T|αβ}, which rotates at the speed ω_{S}, and the fault component \vec{i}_{F|αβ}, which rotates at the speed ω_{F}. The current space vector \vec{i}_{αβ} of the three-phase motor current is calculated according to following equation (3):

$${\underline{\vec{l}}}_{αβ} = {\hat{i}}_{T} \cdot {e}^{i ( {ω}_{S} t )} + {\hat{i}}_{F} \cdot {e}^{i ( {ω}_{F} t + θ )} \qquad ( 3 )$$

In the block diagram shown in FIG. 4, this step is already carried out by the existing field-oriented controller 20 of the pump controller which provides the two currents i_{α} and i_{β} as output variables.

In the sense of the method according to the disclosure, the length of \vec{i}_{F|αβ} is of interest. The dq coordinate system is now rotated at the speed of the harmonic frequency (ω_{K}=ω_{F}). In order to calculate the current vector in dq coordinates, the standard equation for the Park transformation is used, which is designated by the step 30 in the block diagram. The Park transformation can be implemented mathematically according to the following equation:

$${\underline{\vec{l}}}_{dq} = {\underline{\vec{l}}}_{αβ} \cdot {e}^{- i ( {ω}_{F} t )} \qquad ( 4 )$$

If formula (3) is inserted into formula (4), formula (5) arises for the present vector \vec{i}_{dq} in the dq coordinate system:

$${\underline{\vec{l}}}_{dq} = {\hat{i}}_{F} \cdot {e}^{i θ} + {\hat{i}}_{T} \cdot {e}^{i [ ( {ω}_{S} - {ω}_{F} ) t ]} \qquad ( 5 )$$

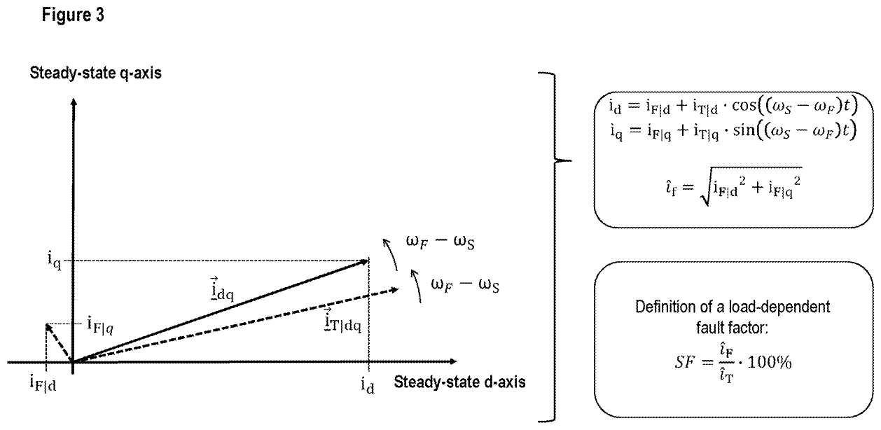

The three-phase current vector \vec{i}_{dq} is equal to the sum of the vectors \vec{i}_{T|dq}, which rotate at the speed (ω_{S}−ω_{F}), and the steady-state vector \vec{i}_{F|dq}, see FIG. 3. If ω_{F} is greater than ω_{S}, both \vec{i}_{dq} and \vec{i}_{T|dq} rotate in the other direction.

Looking at time-dependent variables, i_{d} and i_{q} consist of a DC component and an AC component, as can be seen in equations (6) and (7).

$${i}_{d} = {i}_{F \vert d} + {i}_{T \vert d} \cdot cos ( ( {ω}_{S} - {ω}_{F} ) t ) \qquad ( 6 )$$

$${i}_{q} = {i}_{F \vert q} + {i}_{T \vert q} \cdot sin ( ( {ω}_{S} - {ω}_{F} ) t ) \qquad ( 7 )$$

The initial amplitude î_{f} can be calculated from the geometric sum of i_{F|d} i_{F|q}, see following equation (8).

$${\hat{i}}_{f} = \sqrt{{i}_{F \vert d}^{2} + {i}_{F \vert q}^{2}} \qquad ( 8 )$$

In the block diagram of FIG. 4, this method step is designated by the reference sign 50. If the DC components of i_{d} and i_{q} are ascertained, the amplitude î_{f} can be calculated therefrom. The amplitude of a harmonic can thus be calculated by using simple transformations. A simple and memory-friendly method for calculating the DC components of i_{d} and i_{q} is a first-order filter which is designated by the reference sign 40 in the block diagram of FIG. 4.

For example, a first-order Butterworth filter can be chosen, the transfer function of which can be determined as follows according to equation (9)

$$H ( z ) = \frac{1 - {e}^{{ω}_{c} T}}{z - {e}^{{ω}_{c} T}} , \qquad ( 9 )$$

wherein T is equal to the sampling time of the microprocessor unit. The filter allows simple implementation. However, the cutoff frequency ω_{c} must be chosen to be relatively small in order to remove the oscillation as much as possible. As a result, the time constant of the filter is relatively high, which makes the system slow and can constitute a problem in dynamic systems. This is not critical in the case of use in a pump, however, since no fast load changes are to be expected.

Circulating pumps are usually operated in a pressure-controlled manner. This means that the load and the speed of the pump can change during operation, which means a change in the current consumption of the pump at the same time. In order to take this into account, a severity factor (SF) for a fault, which relates to the current consumption, is calculated. This is illustrated by the reference sign 60 in the block diagram of FIG. 4. Modern circulating pumps have an FOC 10 from which the information about the current consumption can be obtained. In order to ensure the load independence, the severity factor is formed from the relationship of the fault indicator î_{f} and of the amplitude î_{T} of the torque-forming component which is equal to the q current in the used FOC, wherein the d current is regulated to zero:

$$SF = \frac{{\hat{i}}_{f}}{{\hat{i}}_{T}} \cdot 100 \% .$$

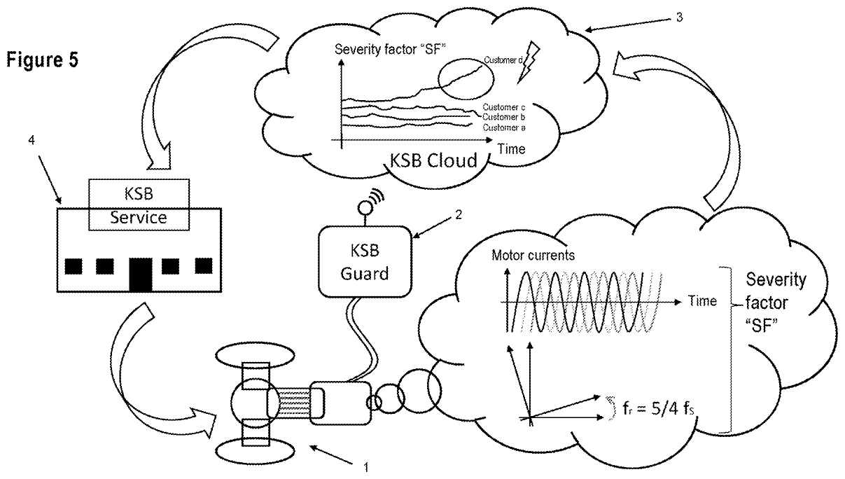

On the basis of the severity factor SF, a decision can then be made about whether or not a fault is present in the pump. The decision can be made locally by the pump controller, see block 70 of FIG. 4. Alternatively, however, it is also possible to set up an external evaluation unit which receives the severity factor SF from a multiplicity of pumps. Such a system is shown by way of example in FIG. 5. The pump 1, here a heat circulating pump, uses the previously presented method to calculate the severity factor SF and transmits it via a gateway 2 to an external evaluation unit 3 which is implemented in a cloud-based manner in the present case. The transmitted data, in particular the severity factor and further operating parameters (e.g. operating point, speed, temperatures, service life) of the pump, are combined in the cloud 3 with corresponding data of further pumps from the same fleet.

Due to the large amount of data available from a complete pump fleet, a comparison of the severity factors under similar boundary conditions (operating point, speed, temperatures, service life) can then be carried out. This is used to filter out faulty pumps and to identify the imminent failure of pumps. A large deviation in the severity factor of one pump from the respective values of the other pumps or from an average value of the other pumps can be interpreted as a degeneration or blockage of the impeller. In this case, the pump owner or pump operator can be informed immediately and, where appropriate, a service technician can be sent over: the information of the pump owner or pump operator and/or the service task can preferably be generated and carried out automatically by the system 4.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-16. (canceled)

17. A method for identifying a fault in an impeller blockage in a centrifugal pump, comprising:
determining the fault frequency f_{r,pump} of at least one fault-indicating harmonic of a motor current on the basis of a fault model, wherein the centrifugal pump has a three-phase drive motor;
calculating a harmonic amplitude î_{f} of the motor current for the at least one determined fault frequency f_{r,pump} by transforming the three-phase motor current into a dq current coordinate system that contains currents i_{d} and i_{q} and rotates at the fault frequency f_{r,pump}, wherein
a geometric sum of direct components of the currents i_{d} and i_{q} in the dq current coordinate system corresponds to the harmonic amplitude î_{f}.

18. The method as claimed in claim 17, wherein the at least one fault frequency f_{r,pump} is calculated based on a stator frequency of the drive motor and a number of pole pairs of the stator, in particular according to
$${f}_{r , pump} = ( 1 \pm \frac{1}{p} ( 1 - s ) ) \cdot {f}_{s} ,$$
where p is the number of pole pairs of the stator, s is the motor slip and fₛ is the stator frequency.

19. The method as claimed in claim 18, wherein direct components of transformed currents i_{d} and i_{q} are ascertained using a low-pass filter, or a first-order low-pass filter, or a first-order Butterworth filter.

20. The method as claimed in claim 19, wherein the transformation into the dq current coordinate system is performed via Park transformation in accordance with:
$${\underline{\vec{l}}}_{dq} = {\underline{\vec{l}}}_{αβ} \cdot {e}^{- i ( {ω}_{F} t )} ,$$
where \vec{i}_{αβ} is a space-vector representation of the three-phase motor current in a stator coordinate system and the angular velocity ω_{F} is calculated from the fault frequency f_{r,pump} according to ω_{F}=2πf_{r,pump}.

21. The method as claimed in claim 20, wherein the transformation of the three-phase motor current into a space-vector representation in a stator coordinate system is performed by a Clarke transformation, wherein the space vector \vec{i}_{αβ} is determined by an existing control element of the pump controller, which control element carries out field-oriented control.

22. The method as claimed in claim 21, wherein a load-independent severity factor SF is ascertained based on the harmonic amplitude î_{f}, by forming the relationship between the harmonic amplitude î_{f} and the amplitude of the torque-generating component of the motor current, or the amplitude î_{T} of the current i_{q}.

23. The method as claimed in claim 21, characterized in that the centrifugal pump monitors the calculated harmonic amplitude î_{f} and/or the severity factor SF during the running time and upon finding an anomaly in the calculated value outputs a fault message and/or triggers an intervention in the pump controller.

24. The method as claimed in claim 23, wherein the method is carried out on an integral microprocessor unit of the pump, a running time of the pump.

25. The method as claimed in claim 24, further comprising: an external central evaluation unit, and wherein two or more centrifugal pumps transmit their calculated values for the harmonic amplitude î_{f} and/or the severity factor SF to the evaluation unit to identify a fault.

26. The method as claimed in claim 25, wherein the central evaluation unit compares two or more of the received values with one another in order to identify anomalies and to detect a fault.

27. The method as claimed claim 24, wherein in addition to the values for the harmonic amplitude î_{f} and/or the severity factor SF, further operating parameters of the pump including the speed n and/or the operating point of the pump and/or a temperature value and/or the service life or running time of the pump are transmitted.

28. The method as claimed in claim 27, wherein for the comparison of the received values, the evaluation unit uses only such pumps the operating parameters of which are identical or are in a predefined range.

29. The method as claimed in claim 25, wherein the evaluation unit is a cloud-based solution.

30. The method as claimed claim 29, wherein the evaluation unit automatically generates a service task for the relevant pump when a fault is detected.

31. A circulation pump, having a three-phase a permanent magnet synchronous motor, and a microprocessor unit which is configured to carry out the method as claimed in 17.

32. A system comprising at least two centrifugal pumps and at least one central evaluation unit having a processor which is configured to carry out the method as claimed in claim 25.
